(19) United States
(12) Patent Application Publication
(10) Pub. No.: US 2026/0250434 A1
(43) Pub. Date: Aug. 27, 2026

(54) ADDITIVE MANUFACTURING WITH A DUAL-CURING RESIN

(71) Applicant: ATOMIC SEMI INC., San Francisco, CA (US)

(72) Inventors: Zhenpeng XU, DALY CITY, CA (US); Sam ZELOOF, SAN FRANCISCO, CA (US); Nate JENNINGS, HUMBLE, TX (US)

(21) Appl. No.: 19/063,050

(22) Filed: Feb. 25, 2025

(51) Int. Cl. C08F 20/10; B29C 64/129; B29C 64/30; B29K 33/04; B29K 105/00; B29K 105/24; B33Y 40/20; B33Y 70/00; C08K 3/36

(52) U.S. Cl. CPC C08F 20/10; B29C 64/30; B33Y 40/20; B33Y 70/00; C08K 3/36; B29C 64/129; B29K 2033/04; B29K 2105/005; B29K 2105/24

(57) ABSTRACT

The disclosed technology provides an innovative dual-curing resin that enables additive manufacturing of robust, high-temperature resistant, and high-precision structures (e.g., micro-structured devices with sub-150 micrometer channels). Composition of the dual-curing resin may facilitate an initial ultraviolet (UV) curing to rapidly solidify the dual-curing resin from a low viscosity state when an object is being formed/printed-thus enabling high-precision printing. Composition of the dual-curing resin may also facilitate a second, thermal curing that significantly improves mechanical robustness and high-temperature resistance for the formed/printed object.

### TECHNICAL FIELD

The present disclosure relates generally to additive manufacturing and associated materials. In particular, some implementations relate to a dual-curing resin for additive manufacturing.

### DESCRIPTION OF RELATED ART

Additive manufacturing may refer to a process of fabricating an object layer-by-layer. 3D printing is an example of additive manufacturing. 3D printing may refer to a computerized process that fabricates a 3D object by depositing (or otherwise solidifying) successive layers of material. Inputs into a 3D printer may include computerized files (e.g., computer-aided design (CAD) files) that include pre-programmed representation(s) of an object to be printed/fabricated. Additive manufacturing/3D printing can enable greater design flexibility/customizability than alternative fabrication techniques. Relatedly, additive manufacturing/3D printing can be less expensive and quicker/more efficient than alternative fabrication techniques.

Stereolithography (sometimes referred to vat photopolymerization) is an example of a 3D printing technology. Stereolithography may involve focusing a patterned image of ultraviolet (UV) radiation (e.g., emitted by a UV laser or light emitting diode (LED)) on to a vat of photopolymer resin. Because photopolymers are sensitive to UV radiation, the photopolymer resin may solidify/polymerize when exposed to UV radiation. Accordingly, the UV may be used to “print” a pre-programmed representation of an object by solidifying/polymerizing the photopolymer resin in a layer-by-layer fashion.

### BRIEF DESCRIPTION OF THE DRAWINGS

The present disclosure, in accordance with one or more various examples, is described in detail with reference to the following figures. The figures are provided for purposes of illustration only and merely depict examples.

FIG. 1 illustrates a flowchart for an additive manufacturing method, in accordance with various examples of the presently disclosed technology.

FIG. 2 illustrates an example micro-structured device design, in accordance with various examples of the presently disclosed technology.

FIG. 3 illustrates an example 3D printer, in accordance with various examples of the presently disclosed technology.

FIG. 4 illustrates an example microfluidic cleaning device, in accordance with various examples of the presently disclosed technology.

FIGS. 5A-5B illustrate perspective views of an example electronic device design, in accordance with various examples of the presently disclosed technology.

The figures are not exhaustive and do not limit the present disclosure to the precise form disclosed.

### DETAILED DESCRIPTION

Traditional fabrication methods for electronic devices, such as sequential layering processes, high-resolution patterning, and other conventional approaches, face challenges accommodating the rapidly growing demand for increasingly miniaturized and complex electronic devices. This is largely due to the lengthy research and development (R&D) cycles associated with these methods. Additionally, such methods often struggle to produce devices with intricate internal structures (e.g., substrates featuring complex internal geometries).

Accordingly, there is a significant need for innovative fabrication techniques that enable greater design flexibility, reduced costs, improved efficiency, and the capacity to rapidly prototype electronics with intricate internal features.

As embodiments of the presently disclosed technology are designed in appreciation of, additive manufacturing (e.g., stereolithography) presents a promising new fabricating/manufacturing solution for electronic devices because it enables greater design flexibility/customizability than traditional methods. Relatedly, additive manufacturing/3D printing is generally less expensive and quicker/more efficient than traditional electronic device fabrication methods. In theory, additive manufacturing could also be used to fabricate complex internal structures directly into a device being fabricated/printed.

However, conventional materials used for additive manufacturing generally lack the combination of mechanical robustness, high-temperature resistance (e.g., the ability to withstand temperatures above 150 degrees Celsius without significant deformation or degradation), and high precision printability required for many electronic device fabrication applications (e.g., fabricating printed circuit board). For example, while stereolithography can facilitate high precision printability, conventional photopolymer resins used in stereolithography generally lack the mechanical robustness and high-temperature resistance required in high-performance electronic applications. While other conventional 3D printing techniques (e.g., extrusion-based methodologies like fused deposition modeling (FDM)) may utilize more robust/temperature resistant materials, these other conventional 3D printing techniques generally lack the high precision printability required for fabricating electronic device substrates. For these reasons, conventional additive manufacturing materials/techniques have generally been considered inadequate for electronic device manufacturing, along with other applications that require high temperature resistance, robust mechanical strength, and high precision features.

Against this backdrop, the presently disclosed technology provides an innovative dual-curing resin that enables additive manufacturing of robust, high-temperature resistant, and high-precision structures (e.g., substrates for micro-structured devices with sub-150 micrometer channels). As described in greater detail below, composition of the dual-curing resin may facilitate an initial UV curing to rapidly solidify the dual-curing resin from a low viscosity state when an object is being formed/printed-thus enabling high-precision printing. Composition of the dual-curing resin may also facilitate a second, thermal curing that significantly improves mechanical robustness and high-temperature resistance for the formed/printed object. For example, depending on formulation, the dual-curing resin may withstand temperatures up to 150 degrees Celsius, 200 degrees Celsius, 250 degrees Celsius, or even 300 degrees Celsius without significant deformation or degradation.

Unlike conventional photopolymer resins used in stereolithography that generally only facilitate UV curing, the dual-curing resin may comprise a thermal initiator (i.e., a compound that creates reactive species when exposed to thermal radiation) that enables the above-described second, thermal curing. This second/thermal curing can increase the cross-linking density of the polymer-thus improving the mechanical strength and temperature resistance of a resultant “dual-cured” device. As alluded to above, this improved mechanical strength and temperature resistance can make the “dual-cured” device suitable for applications that require high temperature resistance and robust mechanical strength. Moreover, the dual-curing resin may comprise additional compounds in particularly calibrated ratios (described in greater detail below) that produce a low viscosity resin (e.g., 100-250 cPs at 25 degrees Celsius) capable of rapid, high-precision solidification/polymerization during initial UV curing.

For example, in various implementations the dual-curing resin may comprise: (1) an acrylate oligomer; (2) one or more crosslinking agents; (3) one or more additives (e.g., silica); (4) a photoinitiator; (5) a UV blocker; and (6) the above-referenced thermal initiator.

The acrylate oligomer may serve as a base for the dual-curing resin and provide a structural back-bone contributing to the dual-curing resin's mechanical strength and high temperature resistance (after dual-curing). In various implementations, the acrylate oligomer may comprise 40-60% of the dual-curing resin by weight, and in more particular implementations, 47-53% of the dual-curing resin by weight. As used herein, acrylate may refer to esters derived from acrylic acid that are capable of participating in free-radical polymerization reactions. An oligomer may refer to a molecule comprising repeating units derived from smaller molecules/monomers. Accordingly, an acrylate oligomer may refer to an oligomer comprising repeating units of acrylate.

The one or more crosslinking agents (sometimes referred to as auxiliary crosslinking agents) can improve crosslinking density of the dual-curing resin. By improving crosslinking density of the dual-curing resin, the one or more crosslinking agents can further enhance the mechanical strength and thermal stability of the dual-curing resin (after dual-curing). In various implementations, the one or more crosslinking agents may comprise 12-20% of the dual-curing resin by weight, and in more particular implementations, 14-18% of the dual-curing resin by weight. As used herein, a crosslinking agent (e.g., Ethoxylated Trimethylolpropane Triacrylate, Urethane Dimethacrylate, etc.) may refer to a molecule/compound comprising two or more reactive ends for chemically attaching to functional groups on other molecules/compounds.

Similar to the one or more crosslinking agents, the one or more additives (e.g., silica, Acryloyl Morpholine, etc.) can modify the rheological properties of the dual-curing resin and also contribute to enhanced mechanical strength and thermal stability after dual-curing. For example, silica can act as a rheology modifier that helps control viscosity of the dual-curing resin, thus reducing/preventing sedimentation or phase separation. Acryloyl Morpholine can function as a reactive diluent that can reduce viscosity of the dual-curing resin. As alluded to above, embodiments may tune viscosity of the dual-curing resin to as low as 100-250 cPs at 25 degrees Celsius. This low viscosity can facilitate high-precision printing/UV curing of the dual-curing resin. In various implementations, the additives may comprise 20-40% of the dual-curing resin by weight, and in more particular implementations, 27-33% of the dual-curing resin by weight.

The photoinitiator can enable UV curing for the dual-curing resin, facilitating rapid and high-precision polymerization/solidification during 3D printing. In various implementations, the photoinitiator may comprise 1-3% of the dual-curing resin by weight, and in more particular implementations, 1.5-2.5% of the dual-curing resin by weight. As used herein, a photoinitiator (e.g., Diphenyl(2,4,6-trimethylbenzoyl)-phosphine oxide) may refer to a molecule/compound that, when exposed to electromagnetic radiation (e.g., UV radiation), absorbs energy and generates reactive species (e.g., free radicals or ions) to initiate the polymerization process.

The UV blocker can further enhance printing precision by controlling the penetration depth of UV radiation and reducing unwanted light scattering. In various implementations, the UV blocker may comprise 0.5% or lower of the dual-curing resin by weight, and in more particular implementations, 0.3% or lower of the dual-curing resin by weight. As used herein, a UV blocker (e.g., Sudan I) may refer to a molecule/compound that absorbs/blocks UV radiation to regulate the UV curing process and improve the overall accuracy/precision of a printed structure.

As alluded to above, the thermal initiator can facilitate a second, thermal curing that enhances the mechanical strength and temperature resistance of the “dual-cured” resin. In various implementations, the thermal initiator may comprise 0.5% or lower of the dual-curing resin by weight, and in more particular implementations, 0.1% or lower of the dual-curing resin by weight. As used herein, a thermal initiator (e.g., Dicumyl Peroxide) may refer to a molecule/compound that decomposes upon exposure to heat, thus generating reactive species (e.g., free radicals) that further propagate the polymerization process during thermal curing.

As alluded to above, the disclosed dual-curing resin may exhibit favorable properties for applications that require high temperature resistance, robust mechanical strength, and high precision feature resolution (e.g., substrates for micro-structured devices, such as electronic devices).

For example, once dual-cured, the dual-curing resin may exhibit robust mechanical strength and high temperature resistance (e.g., temperature resistance above 150 degrees Celsius, and in some formulations, as high as 300 degrees Celsius). Accordingly, the dual-curing resin and associated additive manufacturing methods may be better suited for applications that require robust mechanical strength and high temperature resistance than conventional photopolymer resins used in stereolithography. As alluded to above, many of these conventional photopolymer resins exhibit much lower temperature resistance (e.g., 60 to 90 degrees Celsius) than the presently disclosed dual-curing resin. While some conventional photopolymer resins can exhibit higher temperature resistance than other conventional photopolymer resins (e.g., up to 200-250 degrees Celsius post-curing), such photopolymer resins are generally brittle making them less suitable for applications that require robust mechanical strength (e.g., fabricating electronic devices such as printed circuit board). As used herein, temperature resistance up to a particular temperature (e.g., 150 degrees Celsius) may refer to an ability of a material to withstand the particular temperature without significant deformation or degradation.

As another example, the dual-curing resin can be printed to form features at sub-150 micrometer resolution due in part to its low viscosity (e.g., 100-250 cPs at 25 degrees Celsius) and contributions from the photoinitiator and UV blocker-which facilitate a rapid and precise UV curing. Accordingly, the dual-curing resin (and associated additive manufacturing methods) may be used to fabricate electronic device substrates (and other functional micro-structured devices) with higher resolution features than many traditional additive manufacturing fabrication methods (e.g., extrusion-based methodologies such as fused deposition modeling (FDM), powder bed fusion, etc.).

Relatedly, the disclosed dual-curing resin can make it practical to directly print complex internal microchannels within devices, which is not always achievable with traditional fabrication methods (e.g., conventional multilayer assembly, metal patterning, and sequential build-up processes). This approach can also enable the integration of intricate features (e.g., embedded sensors or other small devices) within electronic device substrates, offering new design possibilities and enhanced functionality.

Embodiments of the presently disclosed technology may also be implemented in innovative additive manufacturing methods made possible by the disclosed dual-curing resin.

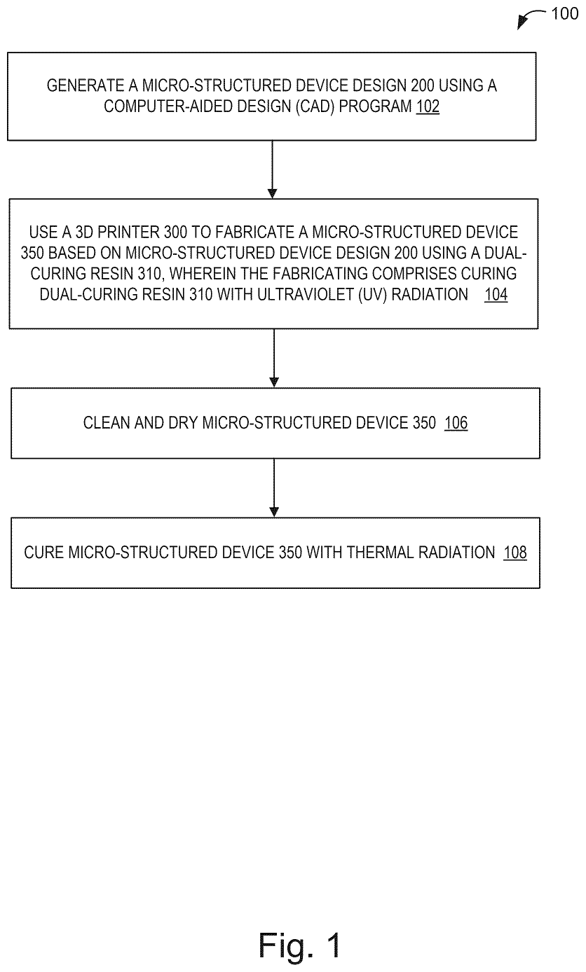

For example, FIG. 1 illustrates a flowchart 100 for an exemplary additive manufacturing method, in accordance with various examples of the presently disclosed technology.

As depicted, step 102 of the additive manufacturing method may involve generating a micro-structured device design 200 (e.g., a device with integrated microchannels) using a 3D CAD software.

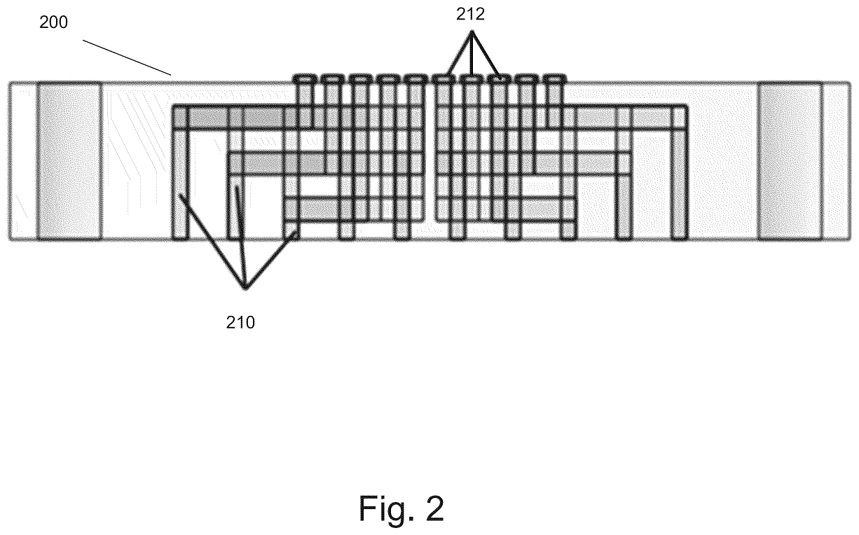

An example for micro-structured device design 200 is illustrated in FIG. 2. As depicted, micro-structured device design 200 may comprise hollow microchannels 210 that connect the top and bottom of micro-structured device design 200.

In some example implementations, hollow microchannels 210 can facilitate precise fluid transport and mixing for various chemical or biological analyses. In certain of these implementations, micro-structured device design 200 may also comprise inlet/outlet ports 212 that enable fluid introduction and collection through hollow microchannels 210 for controlled fluid handling and analysis.

In other example implementations (e.g., implementations involving electronic device fabrication, such as printed circuit board), hollow microchannels 210 can be filled with conductive material. When filled or plated with conductive material, hollow microchannels 210 can facilitate electrical interconnections through micro-structured device design. In certain of these implementations, micro-structured device design 200 may also comprise micro-bumps 212 that provide electrical connections to hollow microchannels 210 (once filled/plated with conductive material).

Benefiting from the unique capabilities of additive manufacturing, design parameters of micro-structured device design 200 can be quickly adjusted, allowing for rapid iteration and optimization based on specific analytical requirements. This can significantly reduce development time and accelerate the research-to-application transition for new diagnostic or analytical methods.

Furthermore, the flexibility of additive manufacturing can permit the creation of hollow microchannels 210 in many shapes or geometries which are generally infeasible to fabricate with traditional microfabrication methods. This design flexibility enables optimized fluid flow patterns and mixing configurations for hollow microchannels 210, which can enhance overall analytical performance and efficiency of micro-structured device design 200. The ability to design and fabricate complex and custom geometries for hollow microchannels 210, along with other features of micro-structured device design 200, can provide additional advantages as well. For example, such customization allows for the integration of specialized functionalities (e.g., embedded sensors) that enhance the capabilities and versatility of micro-structured device design 200.

Referring again to FIG. 1, step 104 of the additive manufacturing method may involve using a 3D printer 300 (e.g., a stereolithography printer) to fabricate a micro-structured device 350 based on micro-structured device design 200 using a dual-curing resin 310.

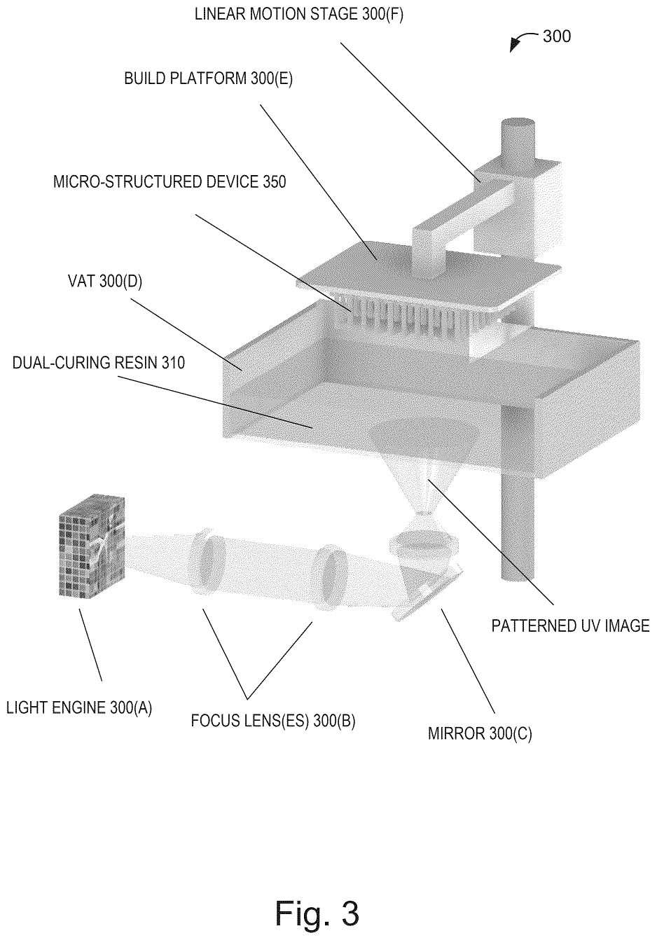

An example of 3D printer 300 and dual-curing resin 310 are depicted in FIG. 3. Dual-curing resin 310 may comprise the dual-curing resin described above. As depicted, 3D printer 300 may be an example of a stereolithography printer. For example, 3D printer 300 may comprise a liquid-crystal display (LCD) mask resin printer, a laser-based stereolithography printer, a digital light processing (DLP) printer, etc.

As alluded to above, 3D printer 300 may use various software-aided techniques to fabricate micro-structured device design 200. For example, micro-structured device design 200 (which may be stored as a 3D CAD file) may be converted into a .stl file. The .stl file may then be sliced into 2D images. The sliced .stl file may then be imported to 3D printer 300. 3D printer 300 may then fabricate/print micro-structured device 350 based on micro-structured device design 200 in a layer-by-layer manner.

As depicted, a stereolithography 3D printer 300 may comprise a light engine 300(A), which in certain implementations may comprise a UV laser or a UV LED. Light engine 300(A) may emit a particularly patterned beam of UV radiation corresponding to layers of micro-structured device design 200. For example, each respective patterned beam of UV radiation may correspond to a respective 2D slice of micro-structured device design 200.

As depicted, 3D printer 300 may also comprise one or more lens(es) 300(B), a mirror 300(C), a vat 300(D), a build platform 300(E), and a linear motion stage 300(F). Here, the one or more lens(es) 300(B) may focus a respective patterned beam of UV radiation onto mirror 300(C). Mirror 300(C) may then reflect the focused patterned beam of UV radiation into/onto vat 300(D). Vat 300(D) may contain dual-curing resin 310 in its low viscosity state. Build platform 300(E) may support the formation of a printed object (e.g., micro-structured device 350). Linear motion stage 300(F) may move build platform 300(E) vertically as successive layers are printed.

As described above, a photoinitiator in dual-curing resin 310 may create a reactive species (e.g., free radicals or ions) when exposed to the focused patterned beam of UV radiation, causing a respective layer of dual-curing resin 310 to solidify/polymerize into a pattern reflecting the patterned beam of UV radiation. As depicted, successive layers of solidified/polymerized dual-curing resin 310 may form micro-structured device 350 (i.e., corresponding to a fabricated version of micro-structured device design 200) onto build platform 300(E).

As alluded to above, embodiments can print precision features (e.g., hollow microchannels) with sub-150 micrometer resolution by intelligently tuning: (1) parameters of 3D printer 300 (e.g., UV radiation exposure times, UV radiation intensity, layer thicknesses, etc.); and (2) composition of dual-curing resin 310 (e.g., concentration of the UV blocker and photoinitiator). Relatedly, multilayered hollow microchannels of micro-structured device 350 can be printed/fabricated in a single printing step, eliminating the need for complex assembly or multiple fabrication stages. In this way, the presently disclosed additive manufacturing method can present an advantage over traditional micro-structured device fabrication methods (e.g., soft lithography, hot embossing, and injection molding) which would typically require multiple complex steps (e.g., master mold creation, polymer casting and surface treatment, etc.) to create similar features.

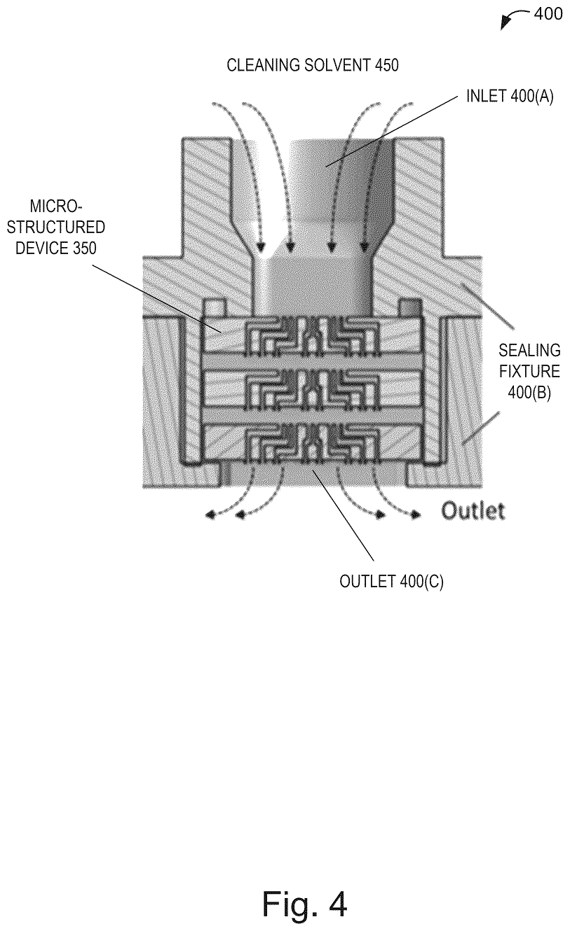

Referring again to FIG. 1, after micro-structured device 350 has been formed and UV cured, step 106 of the additive manufacturing method may involve cleaning and drying micro-structured device 350. As depicted in FIG. 4, in certain implementations this cleaning process may involve placing micro-structured device 350 into a specially designed microfluidic cleaning device 400.

As depicted, microfluidic cleaning device 400 may provide a sealable environment for cleaning the hollow microchannels of micro-structured device 350. As depicted, sealing fixture(s) 400(B) of microfluidic cleaning device 400 may facilitate such sealing.

When micro-structured device 350 is sealed within cleaning device 400, a cleaning solvent 450 (e.g., isopropyl alcohol (IPA)) may be introduced through an inlet 400(A) of cleaning device 400. Cleaning device 400 may then push cleaning solvent 450 through the hollow microchannels of micro-structured device 350 to flush/remove residual material in the hollow microchannels. Here, flow rates for cleaning solvent 450 may be carefully controlled by controlling conditions at inlet 400(A) and an outlet 400(C) of cleaning device 400.

The above-described cleaning process can ensure the small/intricate hollow microchannels of micro-structured device 350 are fully cleaned of residual materials, which can be difficult to achieve using conventional cleaning methods.

After cleaning, micro-structured device 350 can be dried within microfluidic cleaning device using compressed air to remove cleaning solvent 450.

Referring again to FIG. 1, step 108 of the additive manufacturing method may involve curing the cleaned/dried micro-structured device 350 with thermal radiation. As alluded to above, such thermal curing may be facilitated by a thermal initiator in dual-curing resin 310 (from which micro-structured device 350 is formed) that creates reactive species when exposed to thermal radiation-thus further propagating the polymerization process for dual-curing resin 310.

As alluded to above, conventional stereolithography techniques typically only involve UV curing. Accordingly, by thermal curing embodiments can achieve higher mechanical strength and greater temperature resistance than conventional stereolithography techniques.

For example, subsequent rounds of UV curing after a structure is formed may primarily harden an outer shell of the structure, which can lead to weak internal areas. This is in part because, in the case of opaque resins, UV radiation cannot easily penetrate and cure internal structures.

By contrast, thermal curing can better solidify an interior of the structure, making the structure stronger and more reliable, especially for designs with complex internal channels.

In certain implementations, the thermal curing may involve placing micro-structured device 350 in a mold during the thermal curing process. Here, placing micro-structured device 350 in the mold during thermal curing can help maintain the shape of micro-structured device 350 and prevent warping (in certain cases, stereolithographically printed structures may be susceptible to warping after post-curing).

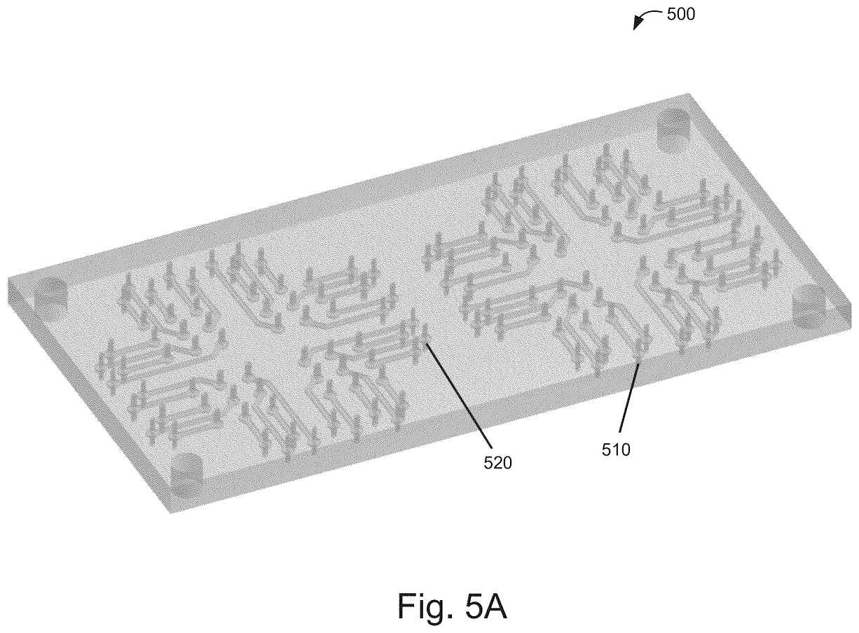

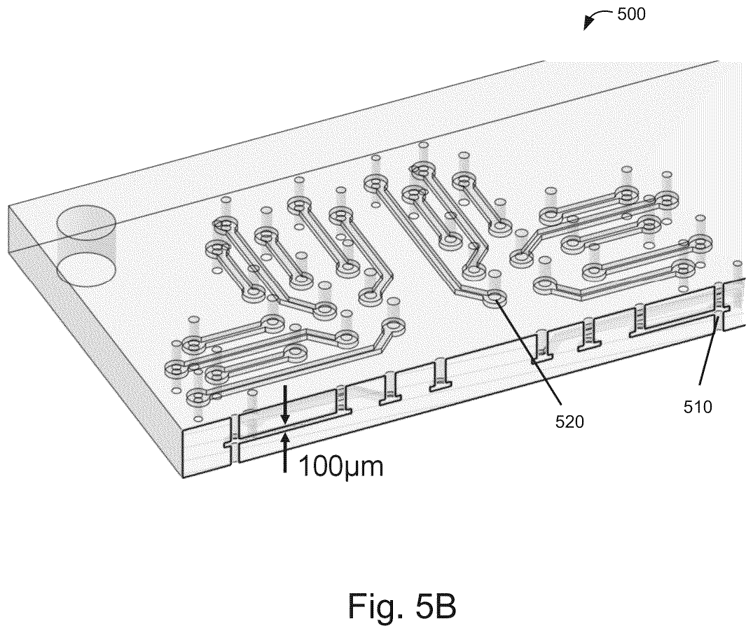

FIGS. 5A-5B illustrate perspective views of an example electronic device design 500, in accordance with various examples of the presently disclosed technology.

In certain implementations, electronic device design 500 may comprise a design for a printed circuit board. In such implementations, electronic device design 500 may comprise through vias 510 and solder pads 520.

While FIGS. 5A-5B illustrate design of a printed circuit board as an illustrative example, it may be appreciated that the disclosed dual-curing resin and associated additive manufacturing methods may be leveraged in other applications. For example, the dual-curing resin's high-temperature resistance (e.g., up to 300° C.) and mechanical strength make it suitable for various high-performance applications in industries such as high-temperature electronic components and microfluidic devices.

For example, the dual-curing resin can be applied to fabricating printed circuit board or other electronic components that require thermal stability at elevated temperatures.

As another example, the high precision of the dual-curing resin in forming microchannels makes it well-suited for manufacturing microfluidic systems used in medical diagnostics, chemical analysis, drug delivery systems, etc.

The above-referenced applications (in addition to various other applications) may thus also benefit from the disclosed resin's dual-curing mechanism, offering flexibility and precision for a variety of high-performance electronic applications.

As used herein, the term module or circuit may be used describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. Various components described herein may be implemented as discrete module or described functions and features can be shared in part or in total among one or more modules. In other words, as would be apparent to one of ordinary skill in the art after reading this description, the various features and functionality described herein may be implemented in any given application. They can be implemented in one or more separate or shared modules in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where modules are implemented in whole or in part using software, these software elements can be implemented to operate with a computing or processing component capable of carrying out the functionality described with respect thereto. A processor or controller of a module might include, for example, one or more processors, controllers, control components, or other processing devices. Processors might be implemented using a general-purpose or special-purpose processing engine such as, for example, a microprocessor, controller, or other control logic. The modules might also include one or more memory components.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A dual-curing resin for additive manufacturing, the dual-curing resin comprising:
an acrylate oligomer;
one or more crosslinking agents;
a photoinitiator; and
a thermal initiator.

2. The dual-curing resin of claim 1, wherein:
the acrylate oligomer comprises 40-60% of the dual-curing resin by weight;
the one or more crosslinking agents comprise 12-20% of the dual-curing resin by weight;
the photoinitiator comprises 1-3% of the dual-curing resin by weight; and
the thermal initiator comprises 0.5% or lower of the dual-curing resin by weight.

3. The resin of claim 1, wherein the dual-curing resin further comprises:
one or more additives comprising silica and a reactive diluent; and
an ultraviolet (UV) blocker.

4. The resin of claim 3, wherein:
the acrylate oligomer comprises 40-60% of the dual-curing resin by weight;
the one or more crosslinking agents comprise 12-20% of the dual-curing resin by weight;
the one or more additives comprises 20-40% of the dual-curing resin by weight;
the photoinitiator comprises 1-3% of the dual-curing resin by weight;
the UV blocker comprises 0.5% or lower of the dual-curing resin by weight; and
the thermal initiator comprises 0.5% or lower of the dual-curing resin by weight.

5. The dual-curing resin of claim 4, wherein:
the acrylate oligomer comprises 47-53% of the dual-curing resin by weight;
the one or more crosslinking agents comprise 14-18% of the dual-curing resin by weight;
the one or more additives comprise 27-33% of the dual-curing resin by weight;
the photoinitiator comprises 1.5-2.5% of the dual-curing resin by weight;
the UV blocker comprises 0.3% or lower of the dual-curing resin by weight; and
the thermal initiator comprises 0.1% or lower of the dual-curing resin by weight.

6. The dual-curing resin of claim 1, wherein:
the acrylate oligomer comprises an oligomer compound comprising repeating units of acrylate;
a respective cross-linking agent comprises a compound comprising two or more reactive ends for chemically attaching to functional groups on other compounds;
the photoinitiator comprises a compound that creates reactive species when exposed to electromagnetic radiation; and
the thermal initiator comprises a compound that creates reactive species when exposed to thermal radiation.

7. The dual-curing resin of claim 1, wherein after UV curing and thermal curing, the dual-curing resin is temperature-resistant up to 150 degrees Celsius.

8. A method for fabricating a micro-structured device, the method comprising:
using a 3D printer to fabricate the micro-structured device from a dual-curing resin, wherein using the 3D printer to fabricate the micro-structured device comprises curing the dual-curing resin with ultraviolet (UV) radiation during the fabrication; and
curing the fabricated micro-structured device with thermal radiation.

9. The method of claim 8, wherein curing the fabricated micro-structured device with thermal radiation comprises:
placing the fabricated micro-structured device in a mold; and
applying the thermal radiation to the mold.

10. The method of claim 8, wherein using the 3D printer to fabricate the micro-structured device comprises forming hollow microchannels through the micro-structured device.

11. The method of claim 10, wherein a respective hollow microchannel comprises a diameter of 150 micrometers or less.

12. The method of claim 10, further comprising, before curing the fabricated micro-structured device with thermal radiation:
cleaning residual material from the hollow microchannels by pushing fluid through the hollow microchannels; and
drying the hollow microchannels with compressed air to remove the fluid.

13. The method of claim 8, wherein the dual-curing resin comprises:
a photoinitiator that creates reactive species when exposed to the UV radiation; and
a thermal initiator that creates reactive species when exposed to the thermal radiation.

14. The method of claim 8, wherein the dual-curing resin further comprises:
an acrylate oligomer comprising 40-60% of the dual-curing resin by weight;
one or more crosslinking agents comprising 12-20% of the dual-curing resin by weight;
additives comprising 20-40% of the dual-curing resin by weight; and
a UV blocker comprising 0.5% or lower of the dual-curing resin by weight;
wherein, the photoinitiator comprises 1-3% of the dual-curing resin by weight and the thermal initiator comprises 0.5% or lower of the dual-curing resin by weight.

15. The method of claim 8, wherein the thermal-cured fabricated micro-structured device is temperature-resistant up to 150 degrees Celsius.

16. A micro-structured device comprising:
a dual-cured resin forming the micro-structured device, wherein the dual-cured resin comprises:
a photoinitiator that creates reactive species when exposed to ultraviolet (UV) radiation, and
a thermal initiator that creates reactive species when exposed to thermal radiation; and
hollow microchannels through the dual-cured resin.

17. The micro-structured device of claim 16, wherein the dual-cured resin further comprises:
an acrylate oligomer comprising 40-60% of the dual-curing resin by weight;
one or more crosslinking agents comprising 12-20% of the dual-curing resin by weight;
one or more additives comprising 20-40% of the dual-curing resin by weight, wherein the one or more additives comprise silica and a reactive diluent; and
a UV blocker comprising 0.5% or lower of the dual-curing resin by weight;
wherein, the photoinitiator comprises 1-3% of the dual-curing resin by weight and the thermal initiator comprises 0.5% or lower of the dual-curing resin by weight.

18. The micro-structured device of claim 17, wherein:
the acrylate oligomer comprises 47-53% of the dual-cured resin by weight;
the one or more crosslinking agents comprise 14-18% of the dual-cured resin by weight;
the one or more additives comprise 27-33% of the dual-cured resin by weight;
the photoinitiator comprises 1.5-2.5% of the dual-cured resin by weight;
the UV blocker comprises 0.3% or lower of the dual-cured resin by weight; and
the thermal initiator comprises 0.1% or lower of the dual-cured resin by weight.

19. The micro-structured device of claim 16, wherein a respective hollow microchannel comprises a diameter of 150 micrometers or less.

20. The micro-structured device of claim 16, wherein the dual-cured resin is temperature-resistant up to 150 degrees Celsius.
